(19) United States
(12) Patent Application Publication
(10) Pub. No.: US 2008/0238944 A1
(43) Pub. Date: Oct. 2, 2008

(54) IMAGE PROCESSING DEVICES AND METHODS OF RECORDING A SCALED PORTION OF AN IMAGE ON A RECORDING MEDIUM

(75) Inventors: Noriko Sugimoto, Kounan-shi (JP); Takahiro Ikeno, Seto-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/049,488

(22) Filed: Mar. 17, 2008

(30) Foreign Application Priority Data
Mar. 30, 2007 (JP) 2007091609

(51) Int. Cl. G09G 5/00

(52) U.S. Cl. 345/660

(57) ABSTRACT

An image processing device includes a display including a first display portion, and a second display portion positioned adjacent to the first display portion. The device also includes a scaling factor designation device configured to designate a scaling factor, and an image display control device configured to display an image in the first display portion. Moreover, the device includes a scaled image display control device configured to apply the scaling factor to the image to generate a scaled image comprising a portion of the image, and to display the scaled image in the second display portion.

### CROSS REFERENCE TO RELATED APPLICATION

The present application claims priority from Japanese Patent Application No. 2007-091609, which was filed on Mar. 30, 2007, the disclosure of which is herein incorporated by reference in its entirety.

### BACKGROUND OF THE INVENTION

1. Field of the Invention

The present invention relates generally to image processing devices. In particular, the present invention is directed towards image processing devices which are configured to simultaneously display an image and a scaled portion of the image on a display, in which the scaled portion of the image is to be formed on a recording medium.

2. Description of Related Art

In a known image processing device, such as a multi-function device, e.g., a printer, an image may be enlarged or reduced based on a scaling factor, and the scaled image may be formed on a recording medium, such as paper. For example, a user may select a scaling factor by operating control buttons provided on the image processing device. Based on the scaling factor selected by the user, the image processing device forms the scaled image on the recording medium.

However, in the known image processing device, the user may not be able to determine whether the selected scaling factor is appropriate for forming a desired, scaled image on the recording medium until after the scaled image is formed on the recording medium. Therefore, the user may have to repeatedly change the selected scaling factor and perform trial recording to obtain the desired, scaled image, which undesirably consumes recording medium.

In general, when the selected scaling factor is greater than a first predetermined scaling factor, a portion of the scaled image is jagged, and a contour or outline of the scaled image is stepped. When the selected scaling factor is less than a second predetermined scaling factor, the scaled image is distorted and illegible.

Another known image processing device, such as Japanese Laid-Open Patent Publication No. 7-253974, is configured to display on a display screen a scaled image to be formed on a print medium. Because the scaled image is displayed in actual size to the user before the scaled image is formed on the recording medium, the user may determine whether there any problems associated with the scaled image before the image is formed on the recording medium.

However, in this known image processing device, when the user changes the scaling factor of the image, a layout of the scaled image to be recorded on the recording medium changes. Consequently, the scanned image which will be recorded on the recording medium may not correspond to the desired, scanned image when the user changes the scaling factor of the image.

### SUMMARY OF THE INVENTION

Therefore, a need has arisen for image processing devices which overcome these and other shortcomings of the related art. A technical advantage of the present invention is that an image process device may be configured to simultaneously display an image and a scaled portion of the image on a display, in which the scaled portion of the image is to be formed on a recording medium, such that a user readily may determine whether there are any problems associated with the scaled portion of the image before the scaled portion of the image is formed on the recording medium. For example, the scaled portion of the image may be displayed in the actual size to be formed on the recording medium. Moreover, when the user discovers a problem associated with the scaled portion of the image, the user may change the scaling factor to address such problems, without having to perform trial printing.

According to an embodiment of the present invention, a method of recording on a recording medium comprises the steps of receiving an image, and scaling the received image to generate a scaled image, wherein the scaled image comprises a portion of the received image. The method also includes the step of displaying the received image, displaying the scaled image adjacent to the received image, and recording the scaled image on the recording medium.

According to another embodiment of the present invention, an image processing device comprises means for receiving an image, and means for scaling the received image to generate a scaled image, wherein the scaled image comprises a portion of the received image. The device also comprises means for displaying the received image, means for displaying the scaled image adjacent to the received image, and means for recording the scaled image on the recording medium.

According to yet another embodiment of the present invention, an image processing device comprises a display comprising a first display portion, and a second display portion positioned adjacent to the first display portion. The device also comprises a scaling factor designation device configured to designate a scaling factor, and an image display control device configured to display an image in the first display portion. Moreover, the device comprises a scaled image display control device configured to apply the scaling factor to the image to generate a scaled image comprising a portion of the image, and to display the scaled image in the second display portion.

According to still yet another embodiment of the present invention, an image processing device comprises a display comprising a first display portion, and a second display portion positioned adjacent to the first display portion. The device also comprises a computer processing unit configured to designate a scaling factor, display an image in the first display portion, and apply the scaling factor to the image to generate a scaled image comprising a portion of the image, and to display the scaled image in the second display portion.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a perspective view of a multi-function device, according to an embodiment of the present invention.

FIG. 2 is a block diagram of the multi-function device of FIG. 1.

FIG. 3 is a flowchart of a scaled image printing process.

FIG. 4 is a flowchart of a scaled image file generating process according to embodiments of the present invention.

FIG. 5 is a flowchart of a scaled image file generating process according to another embodiment of the present invention.

FIGS. 6A-6C are schematics of an image display section and a scaled image display section, according to one of the embodiments of FIG. 4.

FIGS. 7A-7C are schematics showing the image display section and the scaled image display section, according to the other of the embodiments of FIG. 4.

FIGS. 8A-8C are schematics showing the image display section and the scaled image display section, according to the embodiment of FIG. 5.

### DETAILED DESCRIPTION OF EMBODIMENTS OF THE INVENTION

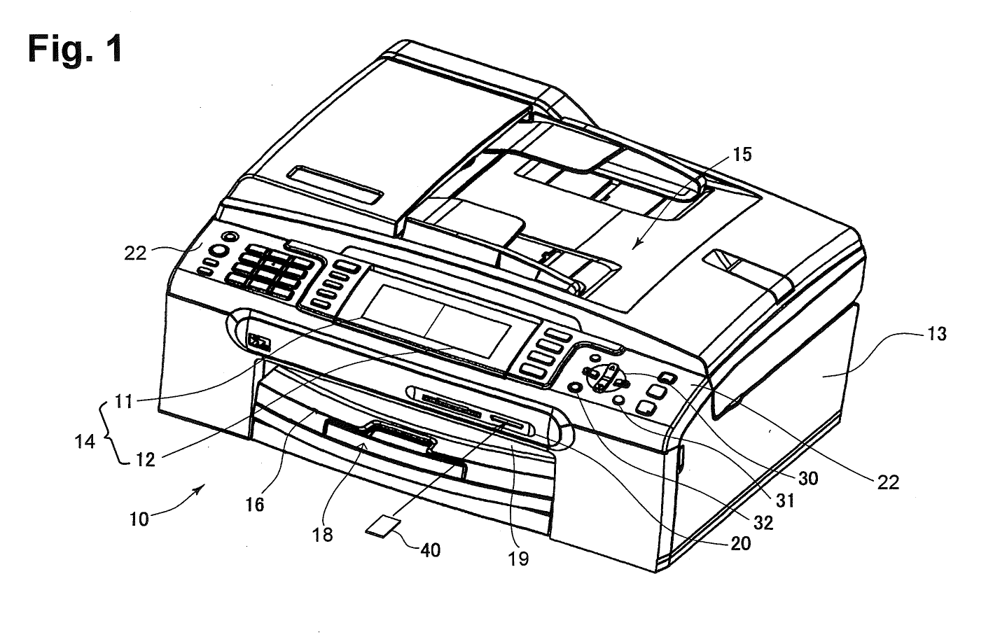

Embodiments of the present invention and their features and technical advantages may be understood by referring to FIGS. 1-8C, like numerals being used for like corresponding portions in the various drawings.

Referring to FIG. 1, an image processing device, such as a multi-function device (MFD) 10, e.g., a printer, may comprise a printing section 13 positioned at an lower portion thereof, and a scanner section 15 positioned at a upper portion thereof. MFD 10 may be configured to perform a printing function, a scanner function, a copying function, or a facsimile function, or any combination thereof.

MFD 10 may be connected to a personal computer (not shown). Images, such as a text comprising characters, may be formed on a recording medium, such as a sheet of paper, based on image data sent from the personal computer. MFD 10 also may be connected to external devices, such as a digital camera, and image data output from the digital camera may be formed on the sheet. Further, images stored in an external storage media 40, such as a memory card, may be formed on the sheet by inserting the external storage media 40 into a slot 20.

Printing section 13 may have an opening 18 formed therethrough on a front face of MFD 10. A sheet feeding tray 16 and a sheet discharging tray 19 may be arranged in a vertical direction to expose a portion of trays 16, 19 from opening 18. Sheet feeding tray 16 may accommodate the sheet, e.g., sheets, therein. Sheets accommodated in the sheet feeding tray 16 may be fed into printing section 13, and a desired image may be formed on the sheets. Sheets having images formed thereon may be discharged to sheet discharging tray 19.

A control panel 22 may be positioned at an upper front portion of MFD 10. Control panel 22 may comprise a display, such as a liquid crystal display 14, comprising an image display section 11 for displaying an image and a scaled image display section 12 for displaying a scaled portion of the image, and various buttons/keys used to operate liquid crystal display 14, printing section 13, and scanner section 15. The various buttons/keys may comprise a directional button (D-button) 30, an end key 31, and an enter key 32. MFD 10 may be operated based on operational instructions from control panel 22. When MFD 10 is connected to a personal computer, MFD 10 also may be operated based on instructions sent from the personal computer via a printer driver or a scanner driver.

Slot 20 may be positioned at a front face of MFD 10. External storage media 40 may be inserted into slot 20. Image data stored in external storage media 40, which is inserted into slot 20, may be read out based on an input from control panel 22. The image data may be displayed in liquid crystal display 14 or the image data may be recorded on a sheet by printing section 13.

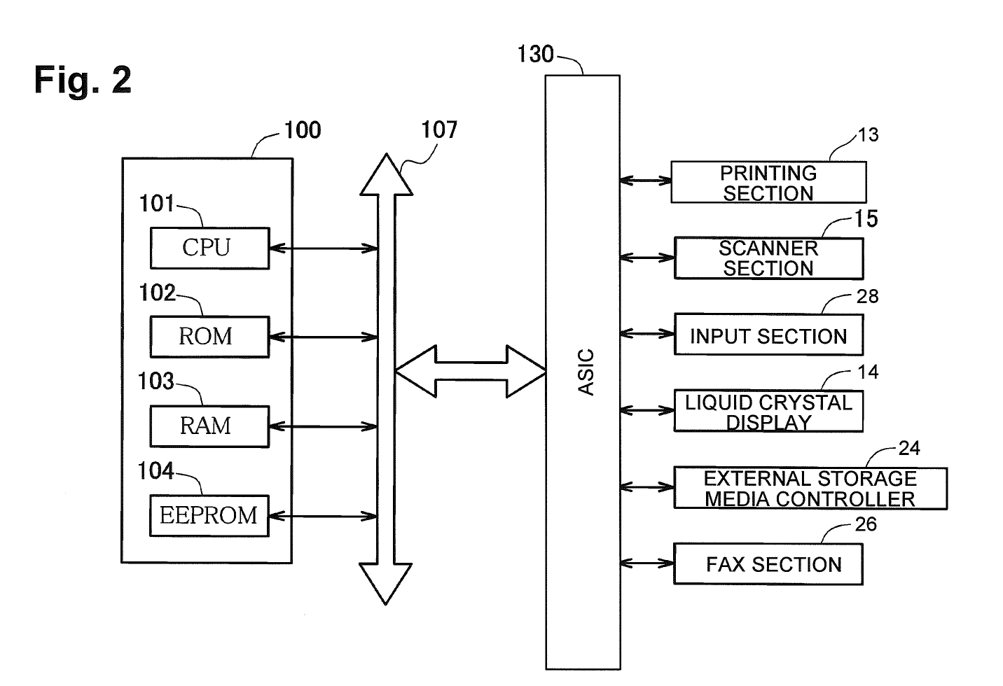

Referring to FIG. 2, MFD 10 may comprise a controller 100 configured to perform an overall control of MFD 10. Controller 100 may comprise a microcomputer comprising a CPU (central processing unit) 101, a ROM (read-only memory) 102, a RAM (random access memory) 103, and an EEPROM (electrically erasable programmable read-only memory) 104.

Controller 100 may be connected to an ASIC (application specific integrated circuits) 130 via a bus 107.

ROM 102 may store programs to control various operations of MFD 10, such as a scaled image printing program and a scaled image file generating program.

RAM 103 may be used as a working area for various processes by CPU 101, and as a storage area for temporarily storing various data to be used by CPU 101 for execution of programs stored in ROM 102.

EEPROM 104 may store settings and flags that need to be retained after power-off.

ASIC 130 may execute signal input and output, based on instructions from CPU 101, between printing section 13, scanner section 15, liquid crystal display 14, an external storage media controller 24 configured to control input and output of data from external storage media 40, a fax section 26, and an input section 28 including D-button 30, end key 31, and enter key 32.

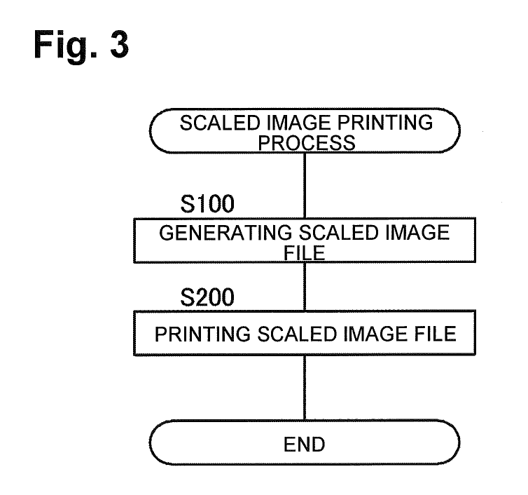

Referring to FIG. 3, a method of displaying the image in image display section 11 and the scaled portion of the image is depicted. In this embodiment, image display section 11 and scaled image display section 12 may be positioned at the left and right sides of liquid crystal display 14, respectively, when viewed from the front side of MFD 10.

Image display section 11 may display images, which are read by scanner section 15, stored in external storage media 40 inserted into slot 20, or transmitted from a personal computer connected to MFD 10.

In this embodiment, a scaling factor may be selected to be greater than or less than 100% with respect to the image read to enlarge or to reduce the image, respectively. Alternatively, the scaling factor may be selected to be 100% with respect to the image read to not change the size of the image.

In the method of FIG. 3, a scaled image file generating process may be performed in S100, in which a scaled image file may be generated for a scaled image to be displayed in scaled image display section 12. Then, a scaled image file printing process may be performed in S200, in which the generated scaled image file may be formed on the sheet.

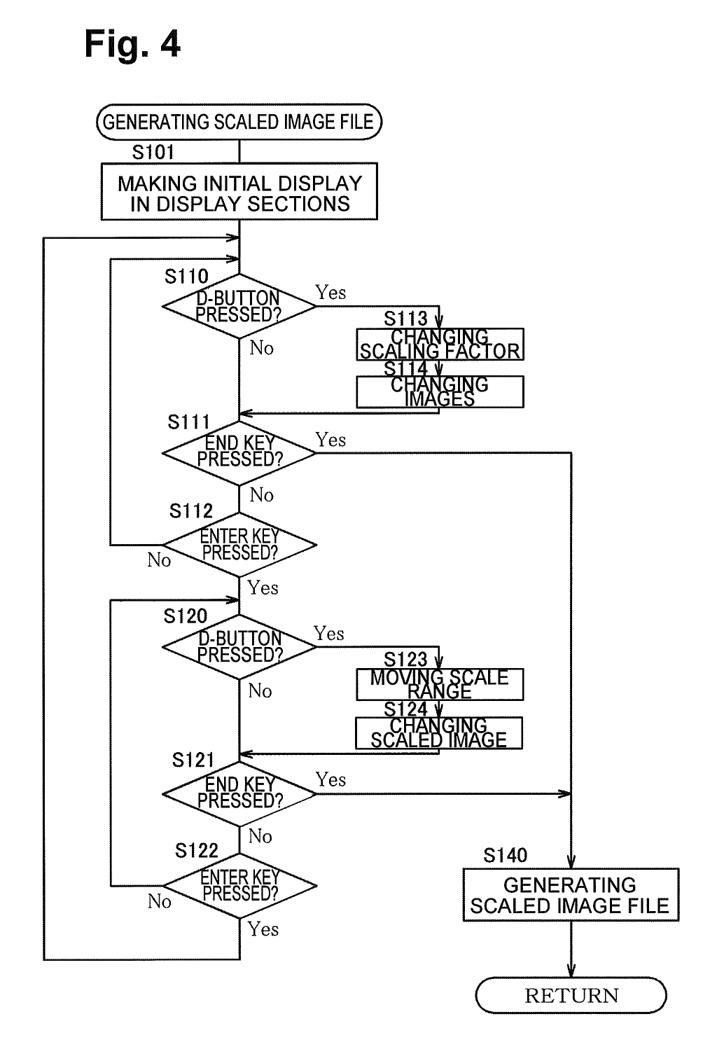

Referring to FIG. 4, a method of generating the scaled image file is depicted. In this method, each time that the user selects the enter key 32 a scaling factor changing operation and a scale range movement operation may be changed. The scaling factor changing operation may be performed to change a scaling factor of the scaled image to be displayed in scaled image display section 12. The scale range movement operation may be performed to move a scale range defined in image display section 11. Specifically, the portion of the image defined in the scale range in image display section 11 may be displayed in scaled image display section 12, e.g., at actual size to be formed on the sheet.

CPU 101 may generate an initial display in image display section 11 and scaled image display section 12 in S101. Specifically, a whole image, e.g., an image designated by a user from images stored in external storage media 40, may be displayed in image display section 11 along with an outline of a sheet. Therefore, a user may preview the image in its entirely prior to printing.

The scale range may have a rectangular shape. An initial scale range may be selected with a center coordinate point of image display section 11 as a left-top point of the rectangular scale range. An initial scaling factor may be for example, 200%.

In addition, image display section 11 may indicate the scaling factor of “200%.” Scaled image display section 12 initially may display a scaled portion, e.g., a middle portion scaled by the scaling factor of “200%,” of the image displayed in image display section 11. The scaled portion displayed in scaled image display section 12 may be displayed in actual size to be formed on the sheet.

In S110, CPU 101 may determine whether D-button 30 is pressed. When CPU 101 determines that D-button 30 is pressed (S110: Yes), the selected scaling factor may be changed in S113. Based on the changed scaling factor, the scaled image displayed in scaled image display section 12 may be changed in S114.

D-button 30 may comprise a right button portion, a left button portion, an up button portion, and a down button portion. When the right D-button 30 is pressed, the selected scaling factor may be increased, for example, by 1%. When the left D-button 30 is pressed, the selected scaling factor may be decreased, for example, by 1%.

Each time the user presses D-button 30 in S110, the selected scaling factor may be changed, and the indication of the scaling factor (e.g., indication of “200%”) in image display section 11 also may be changed. After S114, flow may proceed to S111. When CPU 101 determines that D-button 30 is not pressed (S110: No), CPU 101 may determine in S111 whether end key 31 is pressed.

When CPU 101 determines that end key 31 is pressed (S111: Yes), flow may proceed to S140. When CPU 101 determines that end key 31 is not pressed (S111: No), CPU 101 may determine in S112 whether enter key 32 is pressed. When CPU 101 determines that enter key 32 is pressed (S112: Yes), CPU 101 may determine in S120 whether D-button 30 is pressed. When CPU 101 determines that enter key 32 is not pressed (S112: No), flow may return to S110.

S110-S114 may correspond to the scaling factor changing operation, and S120-S124 may correspond to the scale range movement operation.

When CPU 101 determines that D-button 30 is pressed (S120: Yes), a scale range may be moved in S123. Based on the moved scale range, the scaled image may be changed in S124. For example, when the right D-button 30 is pressed, the scale range may moved rightward by a predetermined amount. Similarly, when the left, top, or bottom D-button 30 is pressed, the scale range may move leftward, upward, or downward, respectively, by a predetermined amount. After S124, flow may proceed to S121.

When CPU 101 determines that D-button 30 is not pressed (S120: No), CPU 101 may determine whether end key 31 is pressed in S121. When CPU 101 determines in S121 that end key 31 is not pressed (S121: No), CPU 101 may determine whether enter key 32 is pressed in S122.

When CPU 101 determines that enter key 32 is pressed (S122: Yes), flow may return to S110. When CPU 101 determines that enter key 32 is not pressed (S122: No), flow may return to S120.

When CPU 101 determines that end key 31 is pressed (S111 or S121: Yes), a scaled image file may be generated in S140 in association with the relevant scale range. The process of generating a scaled image file may end, and the generated scaled image file may be stored in external storage media 40.

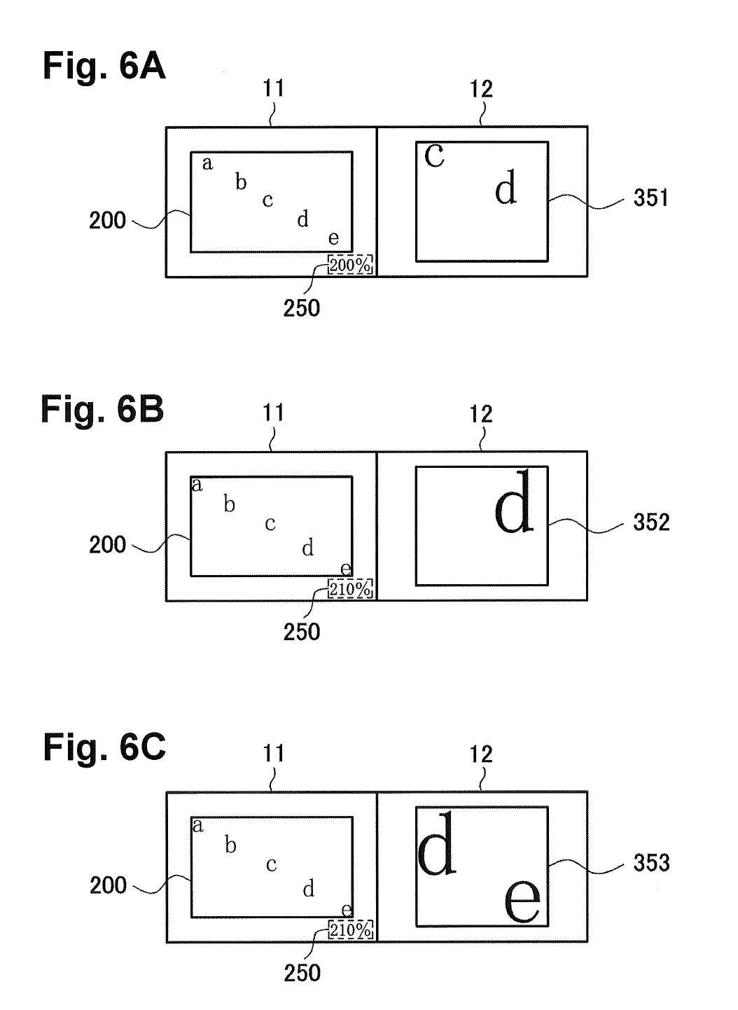

Referring to FIGS. 6A-6C, image display section 11 and scaled image display section 12 according to an embodiment of the present invention is depicted. FIG. 6A shows the initial display made in S101. More specifically, an image designated by a user may be scaled at the scaling factor of 200%. The entire image 200 may be displayed in a middle portion of image display section 11 along with the outline of the sheet. A scaling factor indication 250 may be positioned at a bottom right portion of image display section 11. Scaled image display section 12 may display a scaled image 351. Scaled image 351 may be a middle portion of image 200 displayed in actual size when scaled image 351 is printed at scaling factor of 200%.

As shown in FIG. 6B, the scaling factor may be changed to, for example, 210% using D-button 30. Accordingly, scaling factor indication 250 may be changed to “210%” and image 200 may be enlarged, as represented by a scaled image 352.

Scaled image 352 shown in FIG. 6B may be moved rightward using D-button 30. Accordingly, scaled image display section 12 may display a scaled image 353, as shown in FIG. 6C.

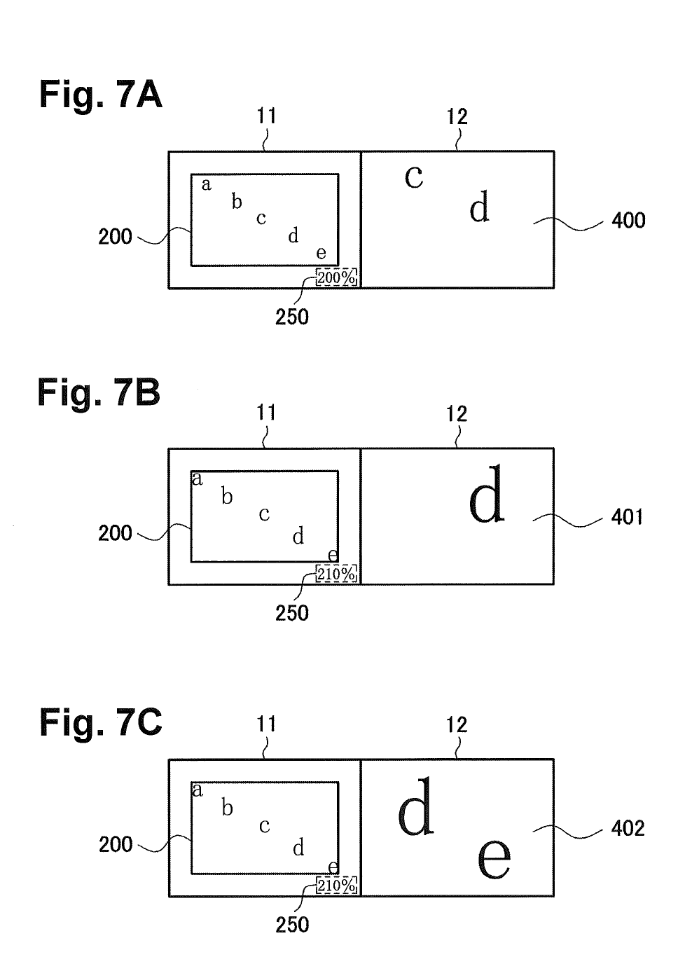

Referring to FIGS. 7A-7C, another embodiment of the present invention is depicted. This embodiment is substantially the same as the embodiment of FIGS. 6A-6C, except that scaled images 351-353 are replaced by scaled images 400-402, and the outline of scaled images 400-402 are not depicted in scaled image display section 12, such that the outline of scaled images 400-402 may correspond to a periphery of scaled image display section 12.

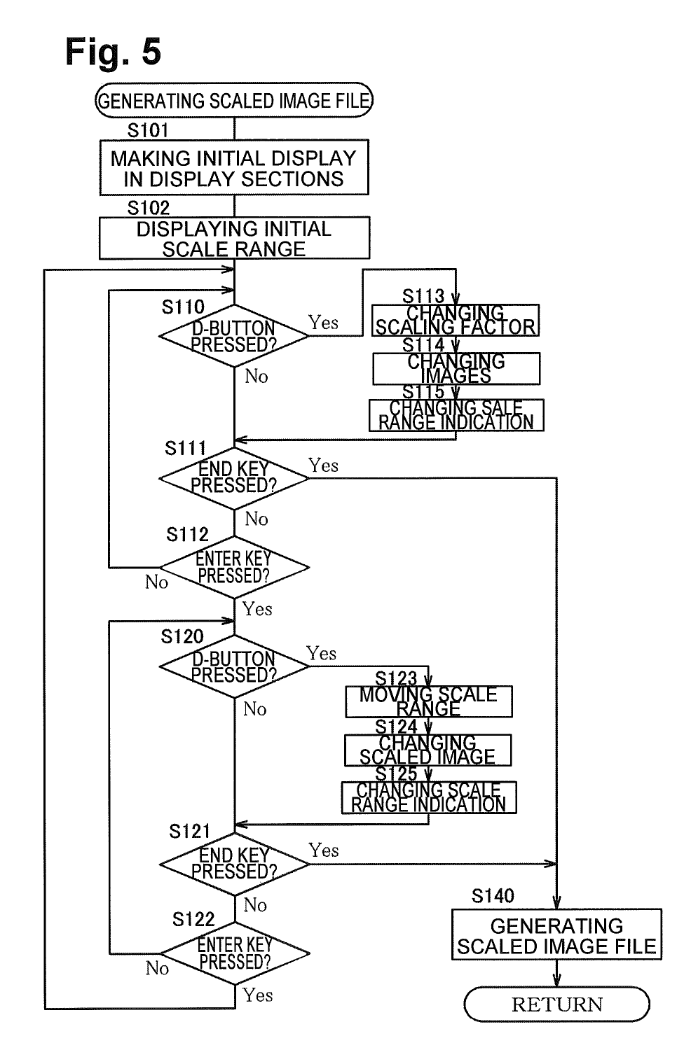

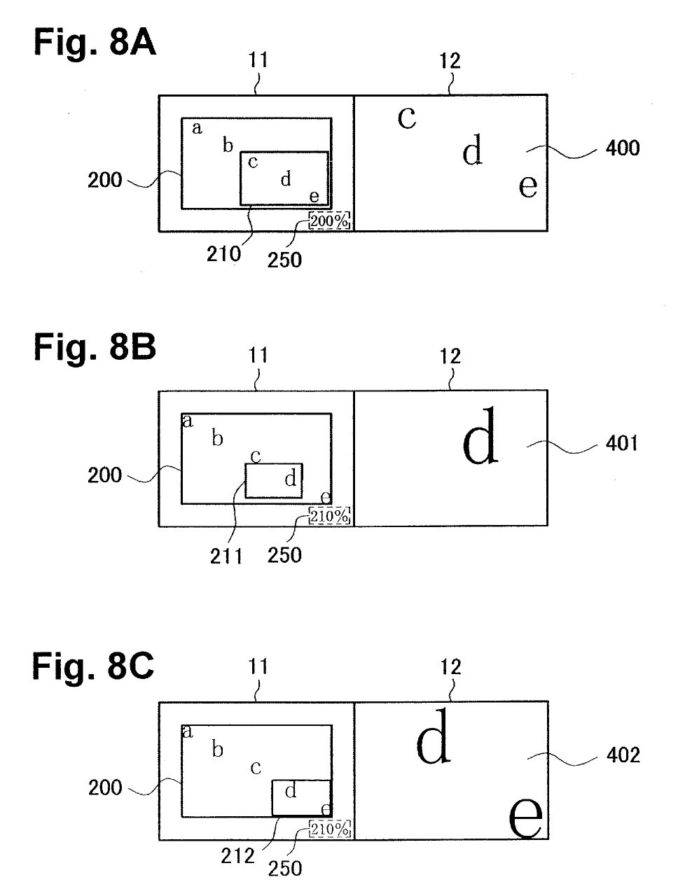

Referring to FIGS. 5 and 8A-8C, yet another embodiment of the present invention is depicted. This embodiment may be substantially the same as the embodiment depicted in FIGS. 6A-6C, except that a scale range may be identified by a frame 210 in image display section 11. In the flowchart of FIG. 5, S102, S115, and S125 are different from the flowchart of FIG. 4. Therefore, only those different steps S102, S115, and S125 are discussed with respect to this embodiment.

In FIG. 5, after S101, an initial scale range may be displayed in S102 in which a scaled image displayed in scaled image display section 12 may be identified in image display section 11 by frame 210 which surrounds a portion of the image displayed in S102. When images displayed in scaled image display section 12 is changed in S114 based on the scaling factor selected in S113, the size of the frame 210 may be changed accordingly in S115.

When the scale range is moved in S123 and the scaled image is changed accordingly in S124, the position of the frame 210 may be changed accordingly in S125.

In an embodiment, the outline of a sheet and frame 210 may be displayed in different colors, such that they may be readily indentified.

While the invention has been described in connection with various example structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A method of recording on a recording medium, comprising the steps of:
receiving an image;
scaling the received image to generate a scaled image, wherein the scaled image comprises a portion of the received image;
displaying the received image;
displaying the scaled image adjacent to the received image; and
recording the scaled image on the recording medium.

2. The method of claim 1, wherein the step of displaying the scaled image comprises the substep of displaying the scaled image at a same size as the scaled image recorded on the recording medium.

3. The method of claim 2, wherein the step of displaying the received image comprises the substep of displaying the received image at a size less than the size of scaled image recorded on the recording medium.

4. The method of claim 1, wherein the step of displaying the received image comprises the substep of displaying the received image at a size less than the size of the scaled image recorded on the recording medium.

5. The method of claim 1, wherein the step of scaling the received image comprises the substeps of:
receiving a scaling factor which is greater than or less than 100 percent; and
scaling the received image based on the scaling factor to generate the scaled image.

6. The method of claim 5, further comprising the step of displaying a scaled range indicator within the displayed received image, wherein the scaled range indicator indicates which portion of the received image corresponds to the scaled image.

7. The method of claim 1, wherein the step of scaling the received image comprises the substeps of:
receiving a first scaling factor which is greater than or less than 100 percent;
scaling the received image based on the first scaling factor to generate a first scaled image;
receiving a second scaling factor which is greater than or less than 100 percent and is different than the first scaling factor;
scaling the received image based on the second scaling factor to generate a second scaled image; and
replacing the first scaled image with the second scaled image.

8. The method of claim 1, further comprising the step of moving the scaled image to alter the scaled image after displaying the scaled image.

9. An image processing device comprising:
means for receiving an image;
means for scaling the received image to generate a scaled image, wherein the scaled image comprises a portion of the received image;
means for displaying the received image;
means for displaying the scaled image adjacent to the received image; and
means for recording the scaled image on the recording medium.

10. The image processing device of claim 9, wherein the means for displaying the scaled image is configured to display the scaled image at a same size as the scaled image recorded on the recording medium.

11. The image processing device of claim 10, wherein the means for displaying the received image is configured to display the received image at a size less than the size of scaled image recorded on the recording medium.

12. The image processing device of claim 9, wherein the means for displaying the received image is configured to display the received image at a size less than the size of the scaled image recorded on the recording medium.

13. An image processing device comprising:
a display comprising:
a first display portion;
a second display portion positioned adjacent to the first display portion;
a scaling factor designation device configured to designate a scaling factor;
an image display control device configured to display an image in the first display portion; and
a scaled image display control device configured to apply the scaling factor to the image to generate a scaled image comprising a portion of the image, and to display the scaled image in the second display portion.

14. The image processing device of claim 13, further comprising a frame image display control device configured to display an outline of the scaled image in the first display portion.

15. The image processing device of claim 13, further comprising a recording medium display control device configured to display an outline of the recording medium in the first display portion, wherein an area of the outline of the recording medium is less than an area of the first display portion.

16. The image processing device of claim 14, further comprising a scaled image adjustment control device configured to move the scaled image within the second display portion, wherein the frame image display control device is further configured to move the frame within the first display portion in response to the movement of the scaled image within the second display portion.

17. An image processing device comprising:
a display comprising:
a first display portion;
a second display portion positioned adjacent to the first display portion; and
a computer processing unit configured to:
designate a scaling factor;
display an image in the first display portion; and
apply the scaling factor to the image to generate a scaled image comprising a portion of the image, and to display the scaled image in the second display portion.

18. The image processing device of claim 17, wherein the computer processing unit is further configured to display an outline of the scaled image in the first display portion.

19. The image processing device of claim 17, wherein the computer processing unit is further configured to display an outline of the recording medium in the first display portion, wherein an area of the outline of the recording medium is less than an area of the first display portion.

20. The image processing device of claim 18, wherein the computer processing unit is further configured to:
move the scaled image within the second display portion; and
move the frame within the first display portion in response to the movement of the scaled image within the second display portion.
